(19) United States
(12) Patent Application Publication
(10) Pub. No.: US 2025/0046547 A1
(43) Pub. Date: Feb. 6, 2025

(54) SWITCHING DEVICE

(71) Applicant: Mitsubishi Electric Corporation, Tokyo (JP)

(72) Inventors: Shinya WATANABE, Chiyoda-ku, Tokyo (JP); Katsuki HOTTA, Chiyoda-ku, Tokyo (JP); Katsuhiko HORINOUCHI, Chiyoda-ku, Tokyo (JP)

(73) Assignee: Mitsubishi Electric Corporation, Tokyo (JP)

(21) Appl. No.: 18/718,806

(22) PCT Filed: Dec. 27, 2021
(86) PCT No.: PCT/JP2021/048644

§ 371 Date: Jun. 12, 2024

(51) Int. Cl. H01H 33/20; H01H 3/38; H01H 33/16; H01H 33/26

(52) U.S. Cl. CPC H01H 33/20; H01H 3/38; H01H 33/16; H01H 33/26; H01H 2033/163

(57) ABSTRACT

A switching device includes: a first contact; a second contact; and a fault detection circuit. The second contact includes a fixed contactor and a movable contactor. When the second contact is energized due to an operation of opening the first contact, the movable contact is separated from the fixed contact by an electromagnetic force generated by a flow of currents in opposite directions through the pair of current-carrying electrodes, and a discharge switch is formed between the movable contact and the fixed contact that are separated. The switching device further includes: a first arc runner electrically connected to the fixed contactor for driving, by an electromagnetic force, arc discharge that occurs when the second contact is opened; and a second arc runner electrically connected to the movable contactor.

### TECHNICAL FIELD

The present disclosure relates to a switching device such as a switch, a circuit breaker, an electromagnetic contactor or a relay that opens/closes an electric circuit.

### BACKGROUND ART

Conventionally, in addition to closing or opening an electric circuit by means of an electric contact or the like, a switching device safely opens the electric circuit upon occurrence of an abnormality such as a short circuit or overcurrent. As an example, the switching device includes: a first contact for preventing a current increase upon occurrence of an abnormality; a second contact provided in parallel with the first contact; a PTC element provided in series with the second contact; and a current-limiting element provided in parallel with the first contact and the second contact. The switching device sequentially opens the first contact and the second contact upon occurrence of an abnormality. In normal state, the switching device conducts current with low resistance loss through the first contact, and when an abnormality occurs, the switching device transfers the current to a circuit having the second contact and the PTC element as a stage prior to transferring the current to the current-limiting element. This can stabilize the current transfer to the current-limiting element while preventing damage to the first contact due to arc discharge, to thereby prevent a current increase (see PTL 1, for example).

### CITATION LIST

### Patent Literature

PTL 1: Japanese National Patent Publication No. 2001-515337

### SUMMARY OF INVENTION

### Technical Problem

On the other hand, when connecting an electric circuit using the conventional switching device, a large current of from several kA to several tens of kA or even higher may flow upon occurrence of an abnormality such as a short circuit condition in the circuit to be connected.

In the conventional switching device, in this respect, when the large current passes through the second contact provided in series with the PTC element, an electromagnetic force generated near an interface between contact surfaces of a pair of contacts included in the second contact may open the contact before the current is transferred to the current-limiting element, resulting in damage to the contact due to are discharge.

The present disclosure has been made to solve the above problem, and an object of the present disclosure is to provide a switching device that can prevent damage to a contact in a simple manner.

### Solution to Problem

According to an embodiment, a switching device includes: a first contact; a second contact provided in parallel with the first contact; a discharge switch provided in parallel with the second contact and energized only when discharge occurs; and a fault detection unit to perform an operation of opening the first contact when a fault is detected. The discharge switch has a function of increasing resistance. The second contact is opened when energized, and discharge that occurs when the second contact is opened is driven to the discharge switch, whereby a current-carrying path is switched from the second contact to a circuit having the discharge switch.

### Advantageous Effects of Invention

The switching device according to the present disclosure can prevent damage to a contact in a simple manner.

### BRIEF DESCRIPTION OF DRAWINGS

FIG. 1 illustrates an appearance configuration of a switching device 1 according to a first embodiment.

FIG. 2 is a circuit configuration diagram of switching device 1 according to the first embodiment.

FIG. 3 illustrates a main part of a commutation unit 10 according to the first embodiment.

FIG. 4 illustrates a main part of a commutation unit 10A according to a second embodiment.

FIG. 5 illustrates a main part of a commutation unit 10B according to a third embodiment.

FIG. 6 illustrates a main part of a second contact 18 #A according to a fourth embodiment.

FIG. 7 illustrates a main part of a commutation unit 10C according to a modification of the fourth embodiment.

FIG. 8 is a circuit configuration diagram of a switching device 1A according to a fifth embodiment.

FIG. 9 is a circuit configuration diagram of a switching device 1B according to a modification of the fifth embodiment.

### DESCRIPTION OF EMBODIMENTS

Embodiments will be described hereinafter with reference to the drawings. In the following description, the same components are denoted by the same reference characters. Their names and functions are also the same. Therefore, a detailed description thereof will not be repeated.

### First Embodiment

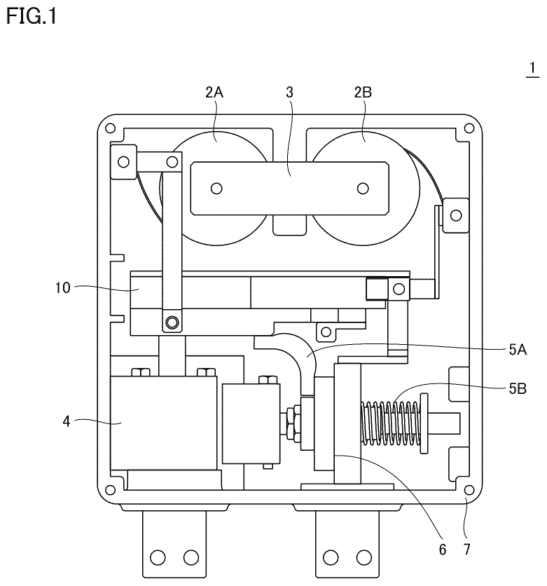

FIG. 1 illustrates an appearance configuration of a switching device 1 according to a first embodiment. Referring to FIG. 1, switching device 1 includes, within an enclosure 7, a fault detection unit 4, a first contact 6, a commutation unit 10 including a second contact, a current-limiting resistor 2 (2A and 2B), and a contact pressure spring SB.

Current-limiting resistor 2 includes current-limiting resistors 2A and 2B. Current-limiting resistors 2A and 2B are connected in series by a resistor connection conductor 3.

First contact 6 has one side connected to commutation unit 10, and the other side connected to commutation unit 10 through a flexible conductor 5A. First contact 6 is pressed into a closed state by contact pressure spring SB in normal operation. Fault detection unit 4 is disposed on a common conductor where a parallel circuit joins.

Fault detection unit 4 detects a magnetic flux density produced from a current within the conductor, and is formed of a movable core that is driven when a current equal to or higher than a certain level flows, and a fixed core, where the movable core is coupled to first contact 6. First contact 6 is driven along with the movable core.

When an abnormality occurs in the parallel circuit and the current flowing through the conductor increases, fault detection unit 4 drives the movable core. Accordingly, the first contact is opened, and the current is transferred to commutation unit 10.

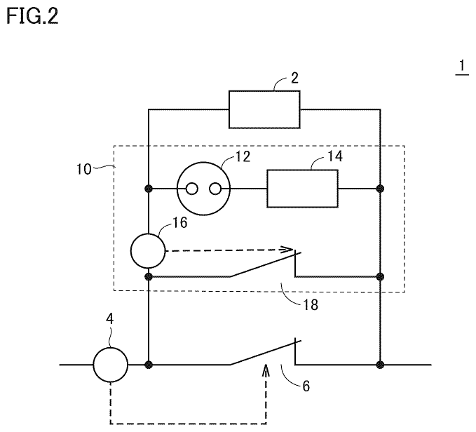

FIG. 2 is a circuit configuration diagram of switching device 1 according to the first embodiment. Referring to FIG. 2, switching device 1 includes first contact 6, and fault detection unit 4 for controlling an operation of opening/closing first contact 6. Commutation unit 10 is connected in parallel with first contact 6. Current-limiting resistor 2 is connected in parallel with first contact 6 and commutation unit 10.

Commutation unit 10 includes a discharge switch 12, a discharge resistor 14, an opening operation unit 16, and a second contact 18.

Second contact 18 is connected in parallel with first contact 6. Opening operation unit 16 maintains second contact 18 in an opened state.

Discharge switch 12 is provided in parallel with second contact 18, is energized only when discharge occurs, and has the function of increasing resistance. Specifically, discharge switch 12 is connected in series with discharge resistor 14, and is connected in parallel with second contact 18. Discharge switch 12 is energized only when arc discharge occurs.

Second contact 18 is opened when energized, and arc discharge that occurs when second contact 18 is opened is driven to discharge switch 12, whereby a current-carrying path is switched from second contact 18 to a circuit having discharge switch 12.

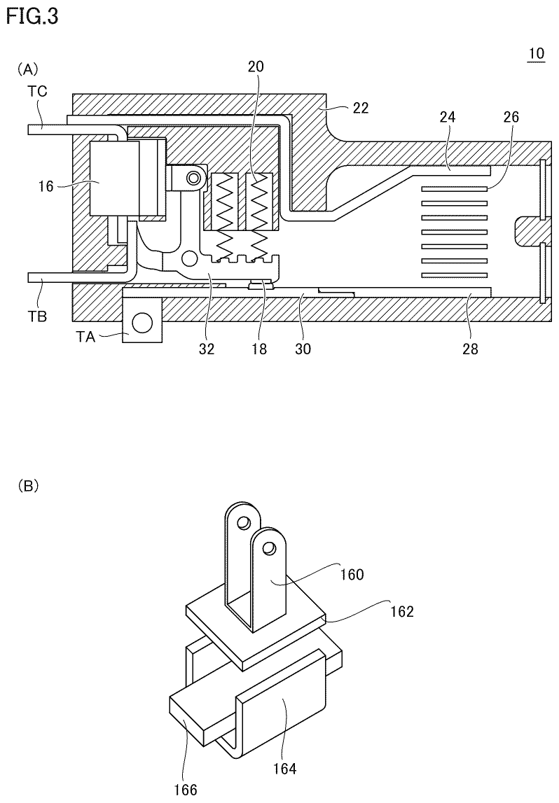

FIG. 3 illustrates a main part of commutation unit 10 according to the first embodiment. Referring to FIG. 3 (A), commutation unit 10 includes an enclosure 22, terminals TA, TB and TC, opening operation unit 16, second contact 18, a contact pressure spring 20, arc runners 24 and 28, and an arc-extinguishing member 26.

Second contact 18 is formed of a pair of elongate current-carrying electrodes facing each other, and includes a fixed contactor 30 having a fixed contact, and a movable contactor 32 having a movable contact that is brought into and out of contact with the fixed contact. Second contact 18 is connected to a connection node between fault detection unit 4 and first contact 6 through terminal TA.

Movable contactor 32 is coupled to contact pressure spring 20, and is pressed into contact with fixed contactor 30 and is conducting in normal operation.

Opening operation unit 16 is coupled to movable contactor 32, and performs an operation of opening the second contact.

Opening operation unit 16 is connected to the connection node between fault detection unit 4 and first contact 6 through terminal TB.

Arc runners 24 and 28 are disposed at an upper portion and a lower portion of enclosure 22. Arc runner 24 is coupled to movable contactor 32. Arc runner 28 is coupled to fixed contactor 30. Arc-extinguishing member 26 is provided between arc runner 24 and arc runner 28.

When second contact 18 is energized due to an operation of opening first contact 6, currents in opposite directions flow through the pair of elongate current-carrying electrodes facing each other. A resulting electromagnetic force separates the movable contact from the fixed contact.

Specifically, second contact 18 is closed by contact pressure spring 20 in normal operation, and when first contact 6 is opened and the current is transferred to a circuit having second contact 18, a current path is formed from terminal TA through fixed contactor 30 and movable contactor 32 to terminal TB.

Each of fixed contactor 30 and movable contactor 32 is formed of a pair of elongate current-carrying electrodes facing each other. When second contact 18 is energized, currents in opposite directions flow through this pair of current-carrying electrodes, to thereby generate a repelling force between the current-carrying electrodes. That is, when second contact 18 is energized, second contact 18 is automatically and rapidly opened by the repelling force.

When second contact 18 is opened, a gap is formed between the fixed contact and the movable contact, and arc discharge occurs between these contacts. The discharge switch is also formed between the fixed contact and the movable contact.

An electromagnetic force is generated within the arc discharge due to a contribution of a magnetic field produced between fixed contactor 30 and movable contactor 32, and the arc discharge is driven toward discharge switch 12.

Discharge switch 12 is connected to are runner 24 and are runner 28. The driven arc discharge is commutated to arc runner 24 and are runner 28, and driven and extended toward the tips of arc runner 24 and are runner 28.

The arc discharge that occurs between arc runner 24 and arc runner 28 increases in discharge resistance with the extension of the arc discharge, and the current is suppressed.

Arc-extinguishing member 26 is provided between are runner 24 and arc runner 28. It is possible to increase the discharge resistance by arc-extinguishing member 26 such as an arc-extinguishing plate provided at the extending end of the arc discharge.

The configuration of commutation unit 10 according to the first embodiment allows electrical resistance in the circuit to increase without using a resistor element such as a PTC element. It is possible to achieve the function of suppressing the current even for a large current of from several kA to several tens of kA or even higher, without constraints imposed by the current used by the PTC element.

In a conventional configuration, when a large current passes through the second contact provided in series with the PTC element, an electromagnetic force generated near an interface between contact surfaces of a pair of contacts included in the second contact may open the contact before the current is transferred to the current-limiting element, resulting in damage to the contact due to arc discharge. Preventing the opening of the contact by the electromagnetic force to avoid the damage to the contact requires a robust switching mechanism to retain the closing of the contact until after the current transfer to the current-limiting element has been completed, which may cause an increase in size of the switching device.

The configuration of commutation unit 10 according to the first embodiment allows the contacts to be promptly separated from each other immediately after second contact 18 is energized, and allows the current to be instantly limited before the current increases by providing the are runners. Therefore, the robust mechanism to retain the closing of the second contact is not required, and switching device 1 can be implemented with a simple configuration without an increase in size.

The arc discharge that occurs at second contact 18 is driven to discharge switch 12 and retained. It is thus possible to suppress wear and tear of second contact 18, to provide longer life through use.

Switching device 1 according to the first embodiment is configured such that current-limiting resistor 2 is provided in parallel with first contact 6. Providing current-limiting resistor 2 in parallel allows a part of the current to be commutated to current-limiting resistor 2 with increase in the electrical resistance of discharge switch 12, thereby further suppressing the wear and tear due to the arc discharge of discharge switch 12.

When interrupting the circuit by switching device 1 according to the first embodiment in coordination with another circuit breaker or switch, it is possible to maintain the effect of limiting the circuit current by current-limiting resistor 2 for a long time until an operation of opening the another circuit breaker or switch is performed.

Commutation unit 10 according to the first embodiment includes opening operation unit 16 that performs an operation of opening second contact 18.

Referring to FIG. 3 (B), opening operation unit 16 includes a connection component 160 that is connected to movable contactor 32, a movable core 162, a fixed core 164, and a current-carrying conductor 166.

Opening operation unit 16 retains the opening of second contact 18. The contacts are promptly separated from each other immediately after second contact 18 is energized, and even when the electromagnetic force acting on movable contactor 32 decreases, opening operation unit 16 can retain second contact 18 in the opened state by driving movable contactor 32.

In this respect, opening operation unit 16 may be formed of an electromagnet including a plurality of cores.

Movable core 164 is coupled to movable contactor 32 through connection component 160.

When a current flows through current-carrying conductor 166 disposed between the cores, an attraction force is generated between the cores. Movable core 162 is driven by this attraction force, which is then converted into a force for opening movable contactor 32.

Current also branches off and flows in opening operation unit 16 through current-limiting resistor 2, when second contact 18 is energized. It is thus possible to increase the speed of opening second contact 18, by using the attraction force of the cores before the opening of movable contactor 32 is completed.

Since opening operation unit 16 is provided, second contact 18 can be continuously retained in the opened state even when the current path is shifted from the circuit having discharge switch 12 to current-limiting resistor 2. Accordingly, it is possible to suppress a reduction in the interval between openings of second contact 18, to help ensure the insulated state between the contacts.

Further, opening operation unit 16 or fault detection unit 4 may receive a power signal from a system different from the system to be opened/closed. Opening operation unit 16 or fault detection unit 4 performs, upon receiving another power signal, an operation of opening second contact 18 or first contact 6. Specifically, a separate control power supply may be provided and connected to opening operation unit 16 or fault detection unit 4, and an operation of opening second contact 18 or first contact 6 may be performed using power from this control power supply. The presence or absence of an abnormality may be determined based on sensor information from a current sensor (not shown) or the like, and when the presence of an abnormality is determined, power may be supplied from the control power supply to thereby start the operation of the switching device based on various types of information. The current sensor is not restrictive, and other sensors may be used.

For example, in this configuration, when connecting a load circuit such as a motor and switching device 1 which involves the generation of an inrush current upon connection of the circuit, an operation of opening first contact 6 or second contact 18 is performed in advance by the power signal described above. It is possible to form a circuit through current-limiting resistor 2 included in switching device 1. Accordingly, it is possible to connect the load circuit while suppressing the inrush current to a low level by current-limiting resistor 2.

Further, since second contact 18 can be opened/closed by the power signal from the different system described above, a command indicating fault clearing can be received from other than the switching device of the present disclosure. This eliminates the need to determine whether the fault has been cleared at fault detection unit 4. Accordingly, even in the case where a current limiting resistor that is set to a large electrical resistance value is provided and the limited current is extremely small, it is possible to stably control the retention of the opening of second contact 18.

### Second Embodiment

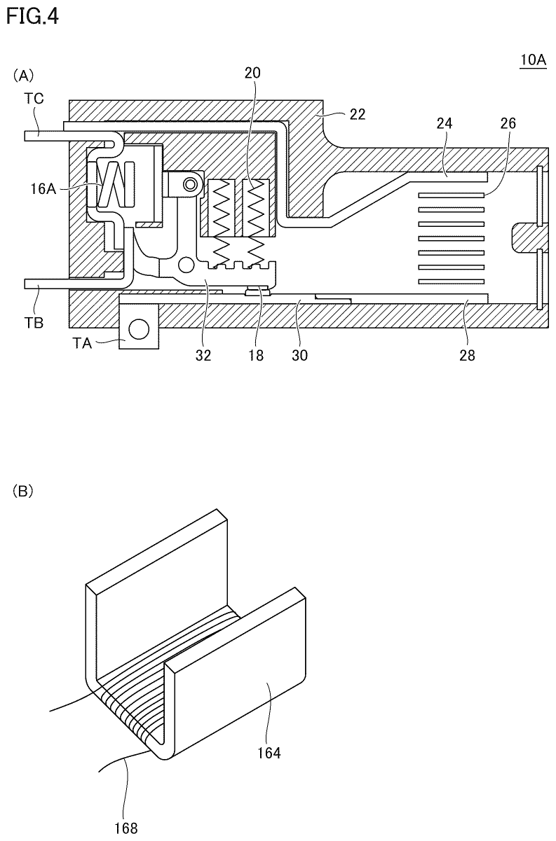

FIG. 4 illustrates a main part of a commutation unit 10A according to a second embodiment. Referring to FIG. 4 (A), the difference from commutation unit 10 is that opening operation unit 16 is replaced by an opening operation unit 16A. The configuration is otherwise the same as that described in FIG. 3, and the detailed description thereof is not repeated.

Opening operation unit 16A is formed of a single coil or a plurality of coils. An operation of opening second contact 18 is performed using a magnetic flux generated by the coil or coils.

Since opening operation unit 16A is formed of a coil, a reactance is generated in the circuit when a current passes through the coil, and the current can thereby be limited to a low level.

A high magnetic flux density is produced around the coil depending on the number of turns in the coil and the passing current. It is possible to generate an electromagnetic force and the like by using the magnetic flux density, to thereby retain the opening of movable contactor 32. By using this electromagnetic force before the circuit having discharge switch 12 is energized, opening operation unit 16A can increase the speed of opening second contact 18.

When the coil is formed of a plurality of coils, movable contactor 32 and arc runner 24 may be electrically connected to each other for one of the coils used, while the other coil may be connected to a power supply of another system, and an operation of opening movable contactor 32 may be performed by a power signal from the another system.

It is not necessarily required to electrically connect one of the coils to movable contactor 32 or are runner 24, and movable contactor 32 may be opened/closed upon receiving a power signal from a system different from the system that is entirely opened/closed.

When a plurality of coils are provided, it is also possible to perform control involving complex commands by adjusting the timings and conditions for receiving power signals.

Opening operation unit 16A can also perform an operation of opening second contact 18 or retain the opening of second contact 18, by employing a core, winding a coil 168 around fixed core 164, and operating movable core 162 using a magnetic flux generated from coil 168, as in the first embodiment with reference to FIG. 4 (B).

### Third Embodiment

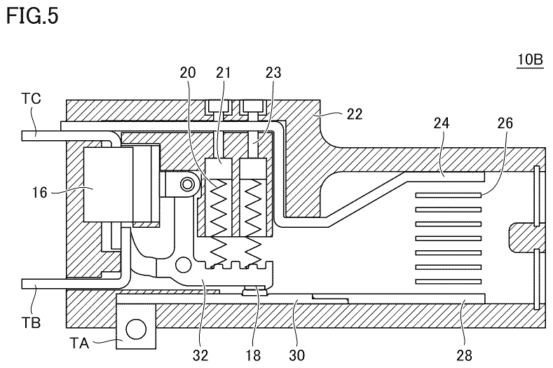

FIG. 5 illustrates a main part of a commutation unit 10B according to a third embodiment. Referring to FIG. 5, the difference from commutation unit 10 is that further components are added to contact pressure spring 20. The configuration is otherwise the same as that described in FIG. 3, and the detailed description thereof is not repeated.

Commutation unit 10B further includes a spring force accumulation component 21 and a contact pressure adjustment mechanism 23.

Specifically, contact pressure spring 20 is provided with spring force accumulation component 21 and contact pressure adjustment mechanism 23.

Contact pressure adjustment mechanism 23 is provided, on the side of contact pressure spring 20 opposite to the side where movable contactor 32 is disposed, with spring force accumulation component 21 that can adjust the amount of force accumulated in contact pressure spring 20. It is possible to adjust the magnitude of contact pressure to push movable contactor 32 by adjusting the position of spring force accumulation component 21.

Accordingly, a difference in time from the opening of first contact 6 to the opening of second contact 18 can be adjusted by the magnitude of contact pressure, which allows second contact 18 to be opened after the current has been completely transferred from first contact 6 to the circuit having second contact 18. If second contact 18 is opened before the current is transferred from first contact 6 to the circuit having second contact 18, first contact 6 is more susceptible to wear and tear because it takes an extended time for arc discharge that occurs when first contact 6 is opened to extinguish. According to the third embodiment, it is possible to prevent the extension of the duration of the arc discharge that occurs when first contact 6 is opened.

### Fourth Embodiment

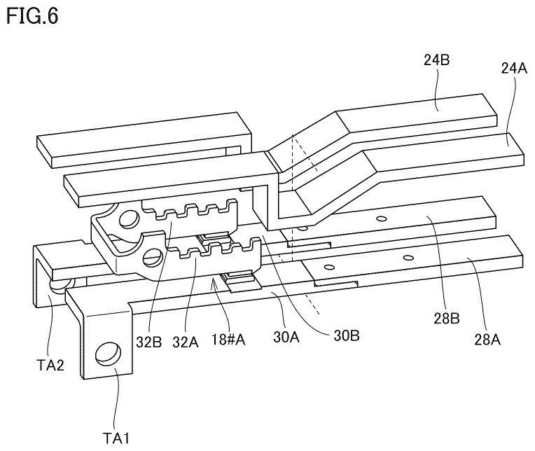

FIG. 6 illustrates a main part of a second contact 18 #A according to a fourth embodiment. Referring to FIG. 6, the difference is that second contact 18 is replaced by second contact 18 #A. The configuration is otherwise the same as those of the other embodiments.

Second contact 18 #A is formed in a U-shape.

Specifically, second contact 18 #A includes a plurality of fixed contactors, and a plurality of movable contactors provided to correspond to the plurality of fixed contactors, respectively.

As an example, second contact 18 #A includes fixed contactors 30A, 30B and movable contactors 32A, 32B. Second contact 18 #A is formed of pairs of fixed contacts and movable contacts, where the plurality of fixed contacts and movable contacts are connected in series.

S When the circuit having second contact 18 #A is energized, second contact 18 #A is almost simultaneously opened. The pairs of contacts included in second contact 18 #A may be more than two pairs in series.

Are runners 28A and 28B are also provided to correspond to fixed contactors 30A and 30B, respectively. Arc runners 24A and 24B are also provided to correspond to movable contactors 32A and 32B, respectively.

With the configuration according to the fourth embodiment, when second contact 18 #A having the plurality of pairs of contacts is opened, a plurality of arc discharges occur from the respective pairs of contacts.

The plurality of arc discharges are driven toward discharge switch 12 by an electromagnetic force.

Discharge switch 12 is connected to are runners 24A, 24B and arc runners 28A, 28B, and the driven arc discharges are driven and extended toward the tips of arc runners 24A, 24B and arc runners 28A, 28B.

The arc discharges that occur between are runners 24A, 24B and are runners 28A, 28B increase in discharge resistance with the extension of the arc discharges, and the current is suppressed.

In this case, an electrode drop voltage also increases with the number of arc discharges that occur. Thus, the effect of limiting the circuit current can be enhanced.

An arc-extinguishing member may be provided between are runner 24A and are runner 28A, and an arc-extinguishing member may be provided between are runner 24B and arc runner 28B.

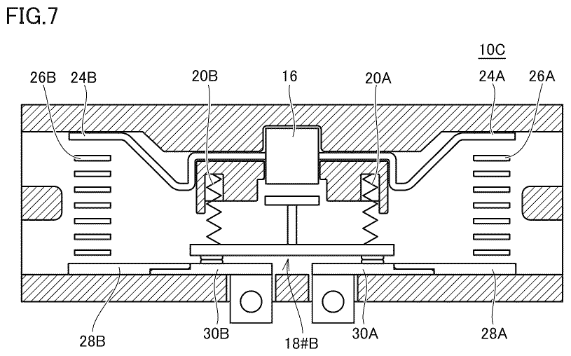

FIG. 7 illustrates a main part of a commutation unit 10C according to a modification of the fourth embodiment. Referring to FIG. 7, the difference from commutation unit 10 is that second contact 18 is replaced by a second contact 18 #B. Second contact 18 #B is linearly formed instead of in a U-shape.

Specifically, second contact 18 #B includes a plurality of fixed contactors, and a plurality of movable contactors provided to correspond to the plurality of fixed contactors, respectively.

As an example, second contact 18 #B includes fixed contactors 30A, 30B and movable contactors 32A, 32B. Second contact 18 #B is formed of pairs of fixed contacts and movable contacts, where the plurality of fixed contacts and movable contacts are connected in series. Movable contactors 32A and 32B are pressed against fixed contactors 30A and 30B, respectively, by contact pressure springs 20A and 20B.

When the circuit having second contact 18 #B is energized, second contact 18 #B is almost simultaneously opened. The pairs of contacts included in second contact 18 #B may be more than two pairs in series.

As an example, fixed contactor 30A is disposed on the right side, and fixed contactor 30B is disposed on the left side.

Arc runners 28A and 28B are provided to correspond to fixed contactors 30A and 30B, respectively. Are runners 24A and 24B are also provided to correspond to movable contactors 32A and 32B, respectively.

An arc-extinguishing member 26A is provided between arc runner 24A and arc runner 28A. An arc-extinguishing member 26B is provided between arc runner 24B and arc runner 28B.

With the configuration according to the modification of the fourth embodiment, when second contact 18 #B having the plurality of pairs of contacts is opened, a plurality of arc discharges occur from the respective pairs of contacts. The plurality of arc discharges are driven toward discharge switch 12 by an electromagnetic force. Discharge switch 12 is connected to are runners 24A, 24B and are runners 28A, 28B, and the driven arc discharges are driven and extended toward the tips of are runners 24A, 24B and are runners 28A, 28B. The arc discharges that occur between are runners 24A, 24B and are runners 28A, 28B increase in discharge resistance with the extension of the arc discharges, and the current is suppressed. In this case, an electrode drop voltage also increases with the number of arc discharges that occur. Thus, the effect of limiting the circuit current can be enhanced.

### Fifth Embodiment

A method for stabilizing the control of current commutation from first contact 6 to commutation unit 10 is described in a fifth embodiment.

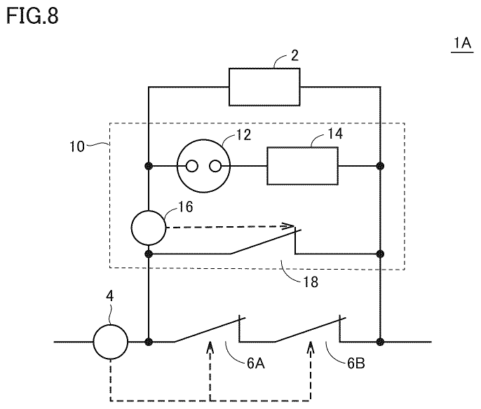

FIG. 8 is a circuit configuration diagram of a switching device 1A according to the fifth embodiment. Referring to FIG. 8, switching device 1A is different from switching device 1 in that first contact 6 is replaced by a first contact 6A.

First contact 6A has two pairs of contacts arranged in series. The pairs of contacts are not limited to two pairs in series, and first contact 6A may include any number of pairs of contacts in series greater than the number of pairs of contacts in series of second contact 18.

With the configuration according to the fifth embodiment, even in the case where second contact 18 is opened before the current transfer from first contact 6A having the plurality of pairs of contacts to commutation unit 10 is completed, an electrode drop voltage generated on first contact 6A having the plurality of pairs of contacts is always higher than an electrode drop voltage generated on second contact 18. It is thus possible to suppress a reduction in speed of the current commutation from first contact 6A having the plurality of pairs of contacts to commutation unit 10, to perform stable commutation control. Therefore, the duration of arc discharge that occurs when first contact 6A is opened can be shortened, and wear and tear of first contact 6A can be suppressed.

Further, it is possible to reduce a difference in time from the opening of first contact 6A having the plurality of pairs of contacts and the opening of second contact 18, to stably perform the commutation control due to the difference between the electrode drop voltages even when both of the contacts are almost simultaneously opened. It is thus possible to more quickly transfer the current from second contact 18 to discharge switch 12, and quickly increase the discharge resistance to thereby promptly limit the circuit current immediately after the occurrence of an abnormality.

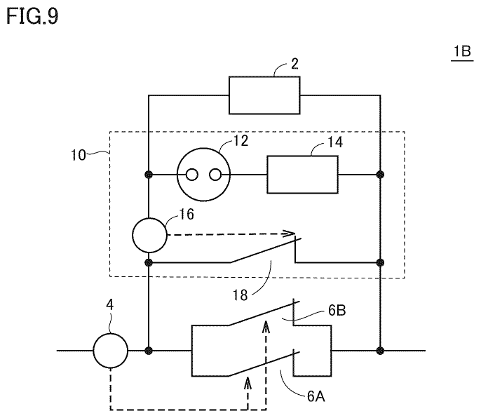

FIG. 9 is a circuit configuration diagram of a switching device 1B according to a modification of the fifth embodiment. Referring to FIG. 9, switching device 1B is different from switching device 1 in that first contact 6 is replaced by a first contact 6B. First contact 6B has a plurality of pairs of contacts provided in parallel. The pairs of contacts are not limited to two pairs in parallel, and more contacts may be provided in parallel.

Note that a plurality of movable electrodes each having a contact may be provided so that a plurality of contact points can be opened/closed, or a single movable electrode may be provided with a contact in a shape having a plurality of contact points.

In the configuration according to the modification of the fifth embodiment, the contact resistance at a contact point is inversely proportional to the square root of a contact pressure load according to the Holm method. It is thus possible to provide a plurality of contact points to distribute and arrange the load for each contact point, to thereby suppressing the contact resistance to a low level.

It is also possible to open the plurality of contact points at different timings, to thereby limit the locations where arc discharges occur upon the opening.

Therefore, it is also possible to provide the following features by devising the material, shape and the like of the last contact to be opened. For example, by employing a high-melting-point material for the last contact to be opened, melting damage upon occurrence of arc discharge can be reduced, and deterioration upon opening/closing of first contact 6B can be prevented. By limiting the facing area of the pair of contacts to a small area at the last contact to be opened, the cross-sectional area of arc discharge can be reduced to a small area, and the drop voltage generated on first contact 6B can thereby further increased upon opening of the contact. The control of current commutation from first contact 6B to commutation unit 10 can also be stabilized.

In the present disclosure, the embodiments can be partially or wholly combined in any way, or the embodiments can be modified or omitted as appropriate, within the scope of the disclosure.

The configurations illustrated as the embodiments described above are exemplary configurations of the present disclosure, and the configurations can be combined with other known techniques, or can be modified by being omitted partially, for example, without going beyond the scope of the present disclosure. Moreover, each embodiment described above may be implemented by appropriately introducing, into the embodiment, processes and configurations described in other embodiments.

It should be understood that the embodiments disclosed herein are illustrative and non-restrictive in every respect. The scope of the present disclosure is defined by the terms of the claims rather than the description above, and is intended to include any modifications within the scope and meaning equivalent to the terms of the claims.

### REFERENCE SIGNS LIST

1, 1A, 1B switching device; 2, 2A, 2B current-limiting resistor; 3 resistor connection conductor; 4 fault detection unit; 5A conductor; SB, 20, 20A, 20B contact pressure spring; 6, 6A, 6B first contact; 7, 22 enclosure; 10, 10A, 10B, 10C commutation unit; 12 discharge switch; 14 discharge resistor; 16, 16A opening operation unit; 18 second contact; 21 spring force accumulation component; 23 contact pressure adjustment mechanism; 24, 24A, 24B, 28, 28A, 28B arc runner; 26, 26A, 26B arc-extinguishing member; 30, 30A, 30B fixed contactor; 32, 32A, 32B movable contactor.

1. A switching device comprising:
a first contact;
a second contact provided in parallel with the first contact;
a discharge switch provided in parallel with the second contact and energized only when discharge occurs; and
a fault detection circuit to perform an operation of opening the first contact when a fault is detected, wherein
the discharge switch has a function of increasing resistance, and
the second contact is opened when energized, and discharge that occurs when the second contact is opened is driven to the discharge switch, whereby a current-carrying path is switched from the second contact to a circuit having the discharge switch, further comprising:
a current-limiting resistor provided in parallel with the first contact and the second contact; and
an opening operation circuit connected in series with the current-limiting resistor for maintaining opening of the second contact while the second contact is energized after being opened.

2. The switching device according to claim 1, wherein
the second contact is formed of a pair of elongate current-carrying electrodes facing each other, and includes a fixed contactor having a fixed contact, and a movable contactor having a movable contact that is brought into and out of contact with the fixed contact,
when the second contact is energized due to an operation of opening the first contact, the movable contact is separated from the fixed contact by an electromagnetic force generated by a flow of currents in opposite directions through the pair of current-carrying electrodes, and
the discharge switch is formed between the movable contact and the fixed contact that are separated,
the switching device further comprising:
a first arc runner electrically connected to the fixed contactor for driving, by an electromagnetic force, arc discharge that occurs when the second contact is opened; and
a second arc runner electrically connected to the movable contactor.

3. The switching device according to claim 2, further comprising an arc-extinguishing member between the first arc runner and the second arc runner.

4. (canceled)

5. The switching device according to claim 1, wherein
the opening operation circuit is formed of a single coil or a plurality of coils, and performs an operation of opening the second contact by using a magnetic flux generated by the coil or coils.

6. The switching device according to claim 1, wherein
the opening operation circuit is formed of an electromagnet including a plurality of cores, and performs an operation of opening the second contact by using an attraction force generated between the cores.

7. The switching device according to claim 1, wherein
the opening operation circuit is provided to be able to receive an externally supplied current command, and
the opening operation circuit performs an operation of opening the second contact in accordance with the external current command.

8. The switching device according to claim 1, further comprising:
a pressing spring for pressing the movable contactor against the fixed contactor; and
a contact pressure adjustment mechanism to adjust a contact pressure of the pressing spring.

9. The switching device according to claim 1, wherein
the second contact includes
a plurality of fixed contactors, and
a plurality of movable contactors provided to correspond to the plurality of fixed contactors, respectively.

10. The switching device according to claim 9, wherein
the plurality of fixed contactors and the plurality of movable contactors are provided in series.

11. A switching device comprising:
a first contact;
a second contact provided in parallel with the first contact;
a discharge switch provided in parallel with the second contact and energized only when discharge occurs; and
a fault detection circuit to perform an operation of opening the first contact when a fault is detected, wherein
the discharge switch has a function of increasing resistance, and
the second contact is opened when energized, and discharge that occurs when the second contact is opened is driven to the discharge switch, whereby a current-carrying path is switched from the second contact to a circuit having the discharge switch, and wherein
the first contact has a plurality of contact points, and
the first contact has more contact points than the second contact.

12. The switching device according to claim 11, wherein
the plurality of contact points of the first contact are provided in parallel.
